(19) United States
(12) Patent Application Publication
(10) Pub. No.: US 2010/0142022 A1
(43) Pub. Date: Jun. 10, 2010

(54) Methods and apparatuses for increasing available power in optical systems

(76) Inventor: Fredrik Sjöström, Taby (SE)

Correspondence Address: HARNESS, DICKEY & PIERCE, P.L.C., P.O. BOX 8910, RESTON, VA, 20195, US

(21) Appl. No.: 12/591,953

(22) Filed: Dec. 4, 2009

Related U.S. Application Data
(60) Provisional application No. 61/193,521, filed on Dec. 5, 2008.

(51) Int. Cl. G02B 26/08; G02B 27/42

(52) U.S. Cl. 359/223.1; 359/558

(57) ABSTRACT

A diffractive optical element (DOE) is included in an apparatus for combining a plurality of laser beams. The DOE combines the plurality of laser beams to generate a plurality of spatially distributed laser beams. The DOE is one of movable or stationary. The spatially distributed laser beams are usable to pattern a workpiece.

### CROSS-REFERENCE TO RELATED APPLICATION(S)

This non-provisional patent application claims priority under 35 U.S.C. §119(e) to U.S. provisional patent application No. 61/193,521, filed on Dec. 5, 2008, the entire contents of which are incorporated herein by reference.

### TECHNICAL FIELD

Example embodiments relate to methods for combining multiple light sources in patterning apparatuses. Example embodiments also relate to apparatuses capable of combining multiple light sources and systems including the same.

### BACKGROUND

Patterning systems for photomasks used in the lithography industry rely on lasers as the primary light source. Depending on writing strategy, light sources utilized in these patterning systems differ. In the case of one dimensional (1D) and two dimensional (2D) (e.g., spatial light modulation (SLM)) chips, for example, a pulsed laser may be used. In another example, continuous wave (CW) lasers are used in acoutso-optic deflector (AOD) based scanning systems. Due to various physical and technical restrictions, however, the output power of conventional CW lasers is limited. In addition, the stability in wavelength and the specific desirable wavelength may impose power restrictions.

Conventionally, various methods of parallelization of writing engines are used to achieve higher throughput (e.g., deliver the same energy to a specific area in shorter time). But, such methods may have some cost disadvantages due to the multiplication of components involved. More specifically, for example, as the number of light sources increases, the number of components responsible for data modulation and scanning increases.

Further, as throughput requirements for patterning systems (e.g., laser based patterning systems) increase, there is a general need for increased laser power. There is also a need for the ability to deliver more energy in a shorter time over a constant area while also driving down the overall costs of electronic devices (e.g. displays, integrated circuits (ICs), memories, etc.).

One example method for increasing laser output power in an optical system is by bundling fibre coupled diodes. This method, however, may present problems with regard to laser light quality. Another example method for increasing laser output power is to use switched lasers (e.g., Q switching). These lasers, however, are not suitable in applications requiring CW laser emission.

Another example for increasing laser output power is to use a single, relatively high power source. FIGS. 1-3 illustrate portions of a conventional patterning system or pattern generator in which a plurality of beams are generated based on a single, relatively high power laser.

Referring to FIG. 1, a single laser beam 108 is diffracted into multiple beams 108-1, 108-2, . . . , 108-n by a diffractive optical element (DOE) 102. The multiple beams 108-1, 108-2, . . . , 108-n are collimated by a collimator lens 104 and focused by a focusing lens 106. The focused beams from the focusing lens 106 are output in parallel to additional elements known of a conventional pattern generator, which are omitted for the sake of brevity.

Referring to FIG. 2, a single laser beam 208 is diffracted into multiple beams 212 by a DOE 202. The multiple beams 212 are collimated by a collimator lens 204 and focused by a focusing lens 206. The focused beams from the focusing lens 206 are output in parallel toward an acousto-optic modulator (AOM) 210. The AOM 210 diffracts and shifts the frequency of the received light beams, and then outputs diffracted and frequency shifted beams to additional known elements of a conventional pattern generator, which are omitted for the sake of brevity.

FIG. 3 illustrates a portion of another conventional pattern generator in which a single, relatively high power laser impinges on a movable DOE.

Referring to FIG. 3, a single laser beam 408 is diffracted into multiple beams 412 by a movable DOE 400. The multiple beams 412 are collimated by a collimating lens 402 and modulated by a modulator 404. A focusing lens 406 focuses the modulated beams toward a deflector 414, which deflects the modulated beams. The beams output from the deflector 414 are output to additional known elements of a conventional pattern generator, which are omitted for the sake of brevity.

The conventional systems shown in FIGS. 1-3 utilize relatively high power lasers. However, such relatively high power laser sources are relatively expensive. Thus, utilizing such laser sources increases costs.

### SUMMARY

Example embodiments provide methods and apparatuses (also referred to herein as optical systems) in which multiple light sources are combined. More specifically, at least some example embodiments provide methods for effectively combining two or more continuous wave (CW) lasers.

Example embodiments also provide patterning apparatuses, pattern generators and patterning systems including apparatuses for combining multiple light sources.

The manner in which the multiple light sources are combined may overcome power restrictions/limitations of single light sources as throughput requirements increase. Further example embodiments may decrease costs associated with utilizing multiple light sources.

### BRIEF DESCRIPTION OF THE DRAWINGS

Example embodiments will be described with regard to the drawings in which:

FIGS. 1 and 2 illustrate portions of conventional patterning systems in which a single laser impinges on a stationary DOE;

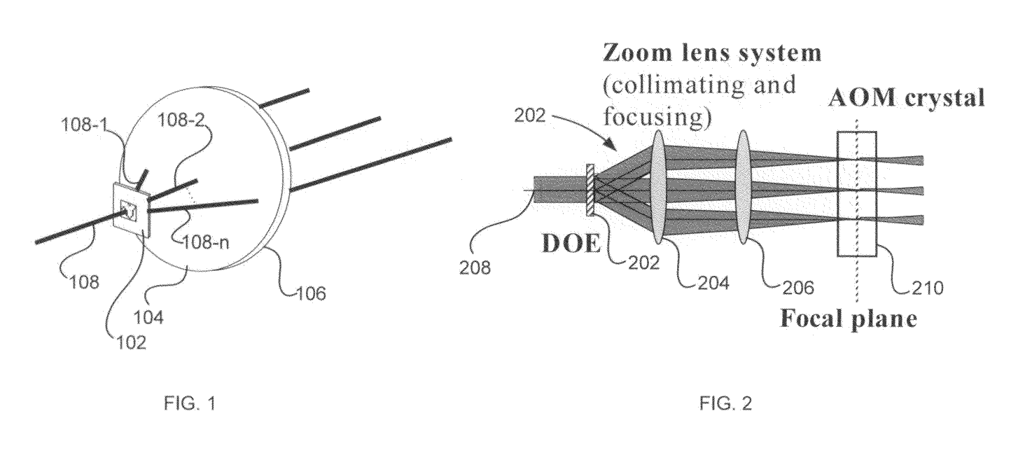

FIG. 3 illustrates a portion of a conventional patterning system in which a single laser impinges on a movable DOE;

FIG. 4 illustrates an apparatus or optical system configured to combine a plurality of laser beams according to an example embodiment;

FIG. 5 shows an apparatus or optical system configured to combine a plurality of laser beams according to another example embodiment; and

FIG. 6 illustrates a pattern generator including an optical system according to an example embodiment.

### DETAILED DESCRIPTION

Example embodiments will now be described more fully with reference to the accompanying drawings, in which some example embodiments are shown. Like reference numerals in the drawings denote like elements.

Detailed illustrative embodiments are disclosed herein. However, specific structural and functional details disclosed herein are merely representative for purposes of describing example embodiments. Example embodiments may be embodied in many alternate forms and should not be construed as limited to only the example embodiments set forth herein.

It should be understood, however, that there is no intent to limit example embodiments to the particular ones disclosed, but on the contrary example embodiments are to cover all modifications, equivalents, and alternatives falling within the appropriate scope. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

According to example embodiments, reading and writing/patterning of a substrate or workpiece is to be understood in a broad sense. For example, reading may include microscopy, inspection, metrology, spectroscopy, interferometry, scatterometry, a combination of one or more of the aforementioned, etc. Writing/patterning may include exposing a photoresist, annealing by optical heating, ablating, creating any other change to the surface by an optical beam, etc.

Example of substrates include: flat panel displays, printed circuit boards (PCBs), substrates or workpieces in packaging applications, photovoltaic panels, etc.

At least some example embodiments describe methods for combining electromagnetic radiation (e.g., a laser beams) from multiple light sources by utilizing a diffractive optical element (DOE). A DOE is an optical device, which influences the wave field by diffraction (e.g., kinoforms, holographic optical elements, etc.). By using different incident angles for the electromagnetic radiation from multiple sources entering the DOE, the resulting beams output from the DOE are spatially distributed (non-overlapping), and thus, interference artefacts may be suppressed and/or prevented.

At least some example embodiments also provide methods for keeping the incident angles constant even if a DOE is moved essentially in the direction of beam propagation.

At least some example embodiments also provide methods for combining many (cheaper) lower power sources rather than using one (expensive) high power source.

At least one example embodiment provides a method for patterning a workpiece covered at least partly with a layer sensitive to electromagnetic radiation. According to at least this example embodiment, the workpiece is patterned with a scanning writing strategy, for example, an acoutso-optic deflector (AOD)-based system utilizing multiple beams.

At least one example embodiment provides an optical system. The optical system includes a diffractive optical element (DOE) configured to generate spatially distributed laser beams in at least one plane based on a plurality of laser beams impinging on the DOE.

According to at least some example embodiments, the DOE may be movable or stationary. The optical system may further include at least two tunable mirrors configured to keep the incident angle of the plurality of impinging laser beams constant. The at least two tunable mirrors may be attached to the DOE. Alternatively, the at least two tunable mirrors may be configured to move such that the at least two tunable mirrors maintain a constant distance from the DOE.

According to at least some example embodiments, the optical system may further include a laser source and an optical lens system. The laser source is configured to emit the plurality of laser beams. The optical lens system is configured to direct the spatially distributed laser beams toward a workpiece. The optical lens system may include at least one of a mirror, lens or combination mirror and lens system.

According to at least some example embodiments, the optical system may further include a collimator lens and a focusing lens. The collimator lens is configured to collimate the spatially distributed laser beams. The focusing lens is configured to focus the collimated beams.

According to at least some example embodiments, the optical system may include: at least one laser source configured to emit the plurality of laser beams; a collimator lens configured to collimate the plurality of laser beams from the DOE; a modulator configured to modulate the collimated beams; a focusing lens configured to focus the modulated beams toward a deflector. The deflector directs the focused beams toward a second focusing lens, which focuses the plurality of laser beams onto a workpiece arranged on a stage.

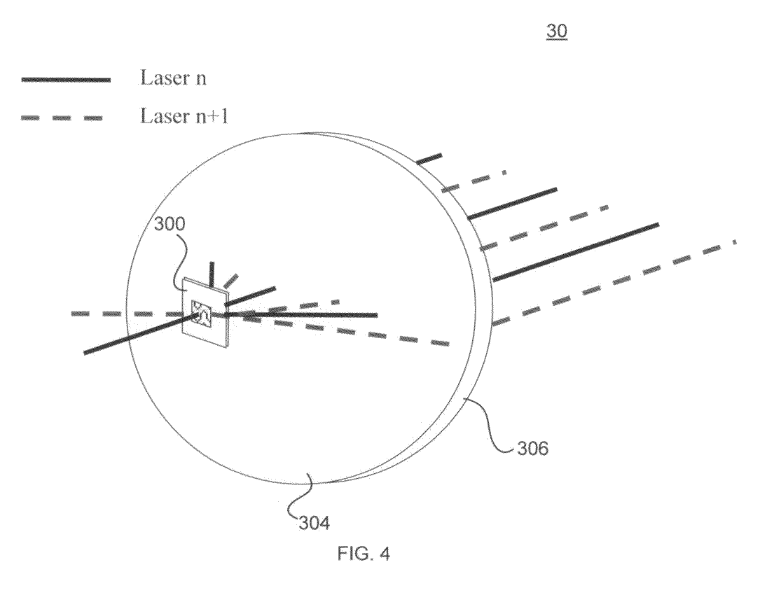

FIG. 4 illustrates an apparatus or optical system configured to combine a plurality of laser beams according to an example embodiment. The apparatus shown in FIG. 4 may be incorporated into and/or used in conjunction with any conventional patterning apparatus, pattern generator or other patterning system.

Referring to FIG. 4, the optical system 30 includes a diffractive optical element (DOE) 300, a collimator lens 304 and a focusing lens 306. In this example, the DOE 300 is a stationary DOE.

As is known, a DOE, such as the DOE 300, is an optical device, which influences the wave field of a laser beam by diffraction. Example DOEs are kinoforms, holographic optical elements, etc.

In FIG. 4, the DOE 300 combines a plurality of laser beams n and n+1 by utilizing a difference in incident angle between the plurality of laser beams n and n+1. More specifically, for example, by having a small angle α between the incoming laser beams n and n+1 incident on the DOE 300, the DOE 300 generates individual beams with a specified spatial distribution. That is, for example, the DOE 300 generates spatially distributed laser beams in at least one plane based on a plurality of laser beams n and n+1 impinging on the DOE 300. The beams generated by the DOE 300 are collimated by the collimator lens 304 and focused by the focusing lens 306.

Although only two beams n and n+1 are shown in FIG. 4, the DOE 300 may receive any number of incoming laser beams and generate multiple individual beams with a specified spatial distribution. The number of beams output from the DOE 300 may be greater than or equal to the number of beams incident on the DOE 300.

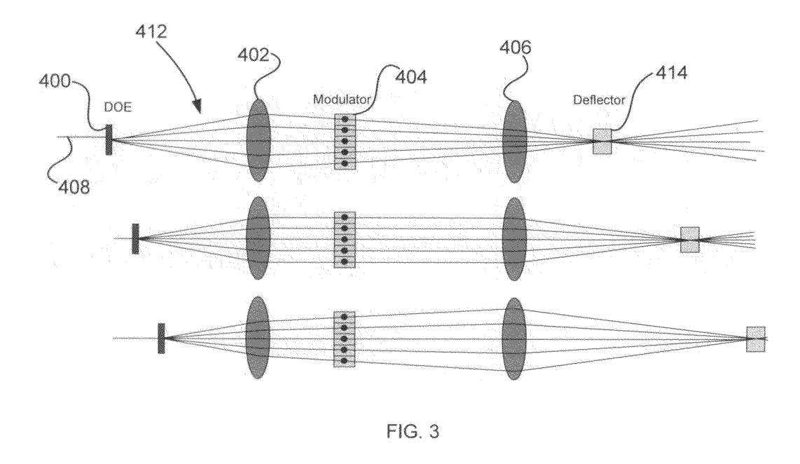

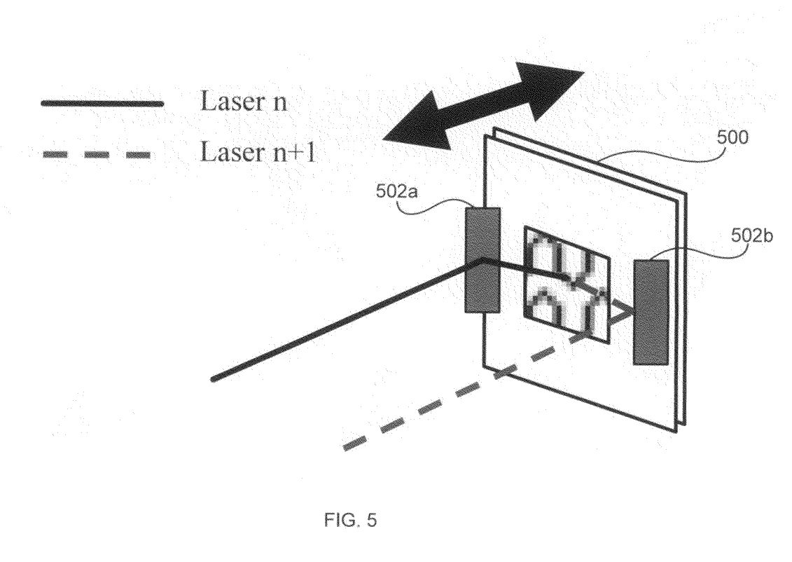

FIG. 5 illustrates an apparatus or optical system configured to combine a plurality of laser beams according to another example embodiment. The apparatus shown in FIG. 5 combines a plurality of laser beams with a difference in incident angle by utilizing a Diffractive Optical Element (DOE) 500. The DOE 500 in FIG. 5 is a movable DOE, which is configured to move in the path of the laser beams as shown and discussed above with regard to FIG. 3, for example.

As was the case with the example embodiment shown in FIG. 4, the apparatus shown in FIG. 5 may be incorporated into and/or used in conjunction with any conventional patterning apparatus, pattern generator or other patterning system.

Referring to FIG. 5, the optical system includes a DOE 500 and tunable mirrors 502a and 502b. The tunable mirrors 502a and 502b are attached to (or configured to move at a constant distance from) the DOE 500. In FIG. 5, the mirrors 502a and 502b are attached at opposite sides of the DOE 500 and ensure that the incident angle of the multiple laser beams in the DOE plane are constant. Although not shown in FIG. 5, the plurality of beams generated by the DOE 500 may be collimated by a collimator lens (e.g., 304 in FIG. 4) and focused by a focusing lens (e.g., 306 in FIG. 4) arranged in the path of the laser beams.

By use of optics (e.g., tunable mirrors 502a and 502b), which are attached to or otherwise held at a constant distance from the DOE, a relatively small angle α between the incoming laser beams may be created. By keeping this relatively small angle α constant, the DOE 500 generates beams with a given, desired or specified spatial distribution.

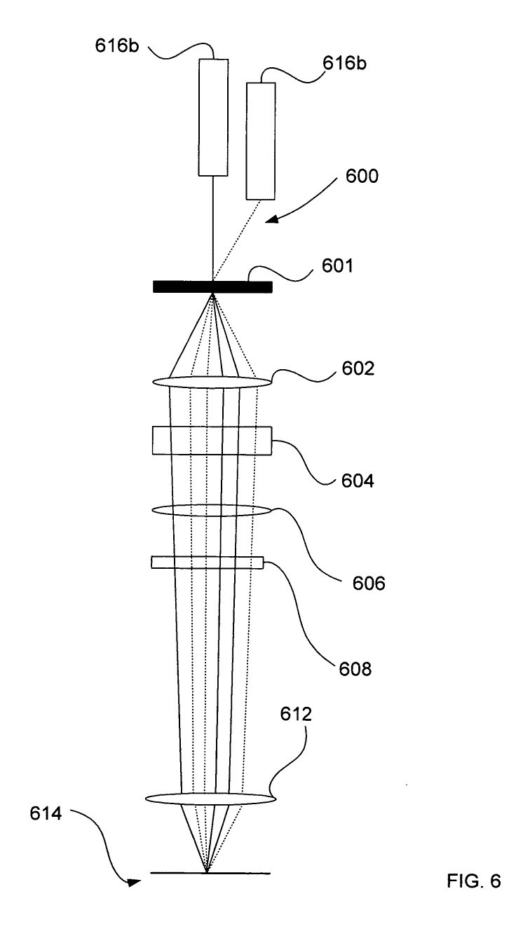

FIG. 6 illustrates a pattern generator including an optical system according to an example embodiment. The DOE 601 shown in FIG. 6 may be one of the stationary DOE shown in FIG. 4 or the movable DOE shown in FIG. 5.

Referring to FIG. 6, the DOE 601 combines a plurality of laser beams 600 output from a plurality of laser sources 616a and 616b by utilizing a difference in incident angle between the plurality of laser beams 600. More specifically, for example, by having a small angle α between the incoming laser beams 600 incident on the DOE 601, the DOE 601 generates individual beams with a specified spatial distribution. The laser beams generated by the DOE 601 are collimated by the collimator lens 602 and modulated by a modulator (e.g., an acousto-optic modulator (AOM)) 604. A focusing lens 606 focuses the modulated beams toward a deflector (e.g., an acousto-optic deflector (AOD)) 608. The deflector 608 directs the modulated beams toward another focusing lens 612, which focuses the beams onto a workpiece (not shown) arranged on a table or stage 614. The focused beams pattern the workpiece, for example, by scanning the workpiece.

Example embodiments provide more cost effective and straight forward methods and apparatuses in which the available power in an optical system, patterning apparatus, pattern generator or other patterning system is increased. In one example, because “parallelization” may be performed before data modulation and scanning the components responsible for data modulation and scanning need not be multiplied. Also, beam quality is essentially conserved.

Example embodiments may be implemented in conventional multi-beam system architectures as shown in FIG. 6 as well as create a technically feasible solution for future high throughput continuous wave (CW) systems. In other examples, example embodiments may be implemented in pattern generators and/or laser processing systems described in U.S. Pat. No. 7,446,857, U.S. Pat. No. 6,624,878 and U.S. Patent Publication No. 2008/0121627, the entire contents of each of which are incorporated herein by reference.

The foregoing description has been provided for purposes of illustration and description. It is not intended to be exhaustive. Individual elements or features of particular example embodiments are generally not limited to that particular example, but are interchangeable where applicable and can be used in a selected embodiment, even if not specifically shown or described. The same may also be varied in many ways. Such variations are not to be regarded as a departure from example embodiments, and all such modifications are intended to be included within the scope of the example embodiments described herein.

What is claimed is:

1. An optical system comprising:
a diffractive optical element (DOE) configured to generate spatially distributed laser beams in at least one plane based on a plurality of laser beams impinging on the DOE.

2. The optical system of claim 1, wherein the DOE is movable.

3. The optical system of claim 1, wherein the DOE is stationary.

4. The optical system of claim 1, further comprising:
at least two tunable mirrors configured to keep an incident angle of the plurality of impinging laser beams constant.

5. The optical system of claim 4, wherein the at least two tunable mirrors are attached to the DOE.

6. The optical system of claim 4, wherein the at least two tunable mirrors are configured to move such that the at least two tunable mirrors maintain a constant distance from the DOE.

7. The optical system of claim 4, wherein the DOE is movable.

8. The optical system of claim 1, further comprising:
at least one laser source configured to emit the plurality of laser beams toward the DOE; and
an optical lens system configured to direct the spatially distributed laser beams toward a workpiece.

9. The optical system of claim 8, wherein the DOE is movable.

10. The optical system of claim 8, wherein the DOE is stationary.

11. The optical system of claim 1, further comprising:
a collimator lens configured to collimate the spatially distributed laser beams; and
a focusing lens configured to focus the collimated beams.

12. The optical system of claim 1, further comprising:
at least one laser source configured to emit the plurality of laser beams;
a collimator lens configured to collimate the spatially distributed laser beams from the DOE;
a modulator configured to modulate the collimated beams;
a focusing lens configured to focus the modulated beams toward a deflector, which directs the focused beams toward a second focusing lens; wherein
the second focusing lens focuses the directed laser beams onto a workpiece arranged on a stage.

13. The optical system of claim 12, wherein the DOE is movable.

14. The optical system of claim 12, wherein the DOE is stationary.

15. A method for combining electromagnetic radiation from multiple light sources, the method comprising:
generating, by a diffractive optical element (DOE), spatially distributed laser beams in at least one plane based on a plurality of laser beams impinging on the DOE.

16. The method of claim 15, wherein the DOE is movable.

17. The method of claim 15, wherein the DOE is stationary.

18. The method of claim 15, further comprising:
maintaining, by at least two tunable mirrors, a constant angle of incidence of the plurality of impinging laser beams.

19. The method of claim 15, further comprising:
emitting the plurality of laser beams; and
directing the spatially distributed laser beams toward a workpiece.

20. The method of claim 15, further comprising:
moving at least two tunable mirrors such that the at least two tunable mirrors maintain a constant distance from the DOE.

21. The method of claim 15, further comprising:
collimating the spatially distributed laser beams; and
focusing the collimated beams.

22. The method of claim 15, further comprising:
collimating the spatially distributed laser beams generated by the DOE;
modulating the collimated beams;
focusing the modulated beams toward a deflector, which directs the focused beams toward a second focusing lens; and
focusing the directed laser beams onto a workpiece arranged on a stage.
